(19) United States
(12) Patent Application Publication
(10) Pub. No.: US 2004/0154383 A1
(43) Pub. Date: Aug. 12, 2004

(54) Multiple indicator flow meter system

(76) Inventors: Darin Kent Woolf, Oceanside, CA (US); Jonathan Day Lucas, Encinitas, CA (US)

Correspondence Address: CATALYST LAW GROUP, APC, 4330 LA JOLLA VILLAGE DRIVE SUITE 220, SAN DIEGO, CA, 92122, US

(21) Appl. No.: 10/733,785

(22) Filed: Dec. 11, 2003

Related U.S. Application Data
(60) Provisional application No. 60/432,754, filed on Dec. 11, 2002.

(51) Int. Cl. G01N 11/00

(52) U.S. Cl. 73/53.01

(57) ABSTRACT

This invention relates to a device and a method by which to directly measure based on pressure and/or temperature data and to control the flow rate, viscosity, density, velocity, pressure or temperature of a variety of fluids in motion with improved reliability and less susceptibility to disturbance of the measuring and control system while, at the same time, offering maximum flexibility for influencing measurement and control data. Components of the flow meter system are described and the methods for calibrating the system and determining pour volumes are explained.

### RELATED APPLICATION

Benefit of priority under 35 U.S.C. 119(e) is claimed herein to U.S. Provisional Application No.: 60/432,754, filed Dec. 11, 2002. The disclosure of the above referenced application is incorporated by reference in its entirety herein.

### BACKGROUND OF THE INVENTION

The invention relates to control and measurement of the flow rate of a fluid.

### BRIEF SUMMARY OF THE INVENTION

Analog flow rate measuring and controlling units are known with which differential pressure measurement is effected by way of an orifice or other restriction in a flow channel to determine the rate of flow. Following that, the value obtained by this measurement is compared with a desired value in a calculating unit. If the actual value differs from the desired value specified the calculating unit emits a correcting signal for application to a proportional valve unit which then initiates a correcting process to cause the measured value of the flow rate to coincide with the desired value.

A problem with the known flow rate measuring and controlling means is that they are relatively inflexible and cannot readily be matched to changes occurring in fluid properties. Processing of the measurement and control data is substantially predetermined by the system components. For a flowing fluid, the initial fluid properties change with time due to the effect of external influences (e.g., heat) which may occur in the course of flow. Flow meter components such as sensors, analog amplifiers, analog comparators, and the like are influenced by such drifts in properties. As a result, calculated flow rates will substantially differ from actual flow rates.

### BRIEF DESCRIPTION OF THE FIGURES

FIG. 1 is an exploded view of the flow meter of the current invention

FIGS. 2 a-c are top view, cross-sectional side view and bottom view, respectively, of the flow block with recess.

FIG. 3 is a bottom view of the flow block with recess highlighting sensor port

FIGS. 4 a-b are schematic views of flow block with sensor ports highlighting sensor port to sensor port reading models.

### DETAILED DESCRIPTION OF THE INVENTION

It is, therefore, an object of the instant invention to provide a device and a method by which to measure and control the flow rate of a fluid with improved reliability and less susceptibility to disturbance of the measuring and control system while, at the same time, offering maximum flexibility for influencing measurement and control data.

This document describes a Multiple Indicator Flow Meter and accompanying system that can be used in a characterization process. Components of the flow meter system are described and the methods for calibrating the system and determining pour volumes are explained. The Multiple Indicator Flow Meter of the current invention is useful with a variety of flow systems; however, by way of example only and not limitation, the current invention is described herein as embodied in two types of flow meter systems used with a soda fountain. First, the entire system is described using a “Gage Pressure Type” of flow meter. This means the flow meter uses only absolute or gage pressure sensors. Alternatively, variations of the meter are described that compose a second embodiment of the flow meter. This is a “Differential Pressure Type” meaning that the meter incorporates differential pressure sensors where both sides of the sensor are exposed to pressures within the meter. Other improvements are also noted.

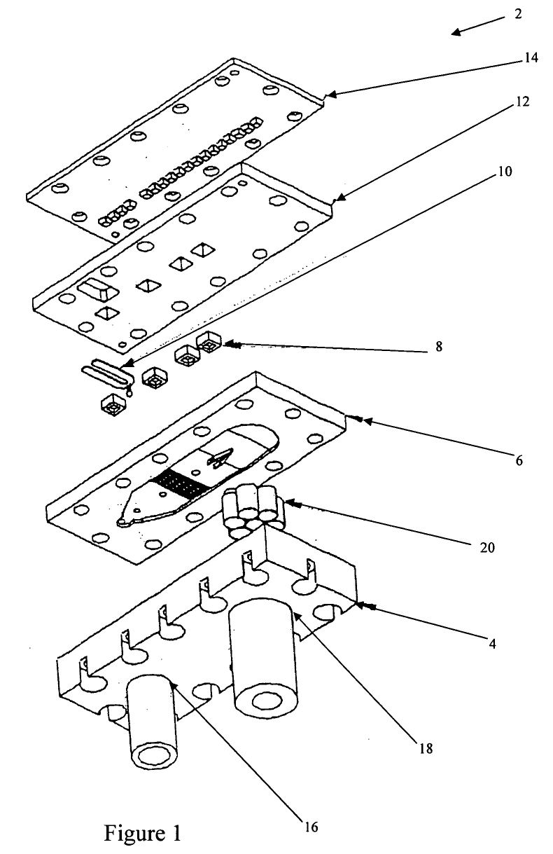

As described herein and depicted in FIG. 1, the flow meter system 2 comprises the following components and methods: a plastic flow body comprising a base member 4 and a flow block 6; four MEMS pressure sensors 8; a thermistor 10; a sensor housing 12; a circuit board making contact with the pressure sensors and thermistor (Contact Board) 14; a circuit board to drive the pressure sensors and thermistor (Analog Test Board); a piston pump; a scale; and data acquisition/process control hardware and software for delivering a method of calibration and a method of evaluating data to determine pour volume. While the flow meter system of the current disclosure comprises the above elements, it is to be noted that a variety of alternatively designed flow meter systems can employ the inventive sensor device. Such variations do not depart from the spirit of the current invention.

The flow body comprises two flat pieces made of polycarbonate plastic, ceramic or other suitable material and termed the base member 4 and the flow block 6. The base member 4 has two optimally spaced holes, one for a fluid inlet 16 and the other for a fluid outlet 18. Into the inlet hole 16 is glued an inlet tube to allow for a fluid collection, and, similarly, to the outlet hole 18 is glued an outlet tube to allow for fluid drainage. The inlet tube is the smaller of the two shown in FIG. 1. At the outlet hole 18 a small section of thin-walled plastic honeycomb 20 is inserted to reduce the development of vortices in the exiting fluid. In an alternative embodiment, the honeycomb 20 is removed and outlet hole 18 comprises a rounded exit transition to reduce vortices. Other methods for reducing vortices are well known in the art.

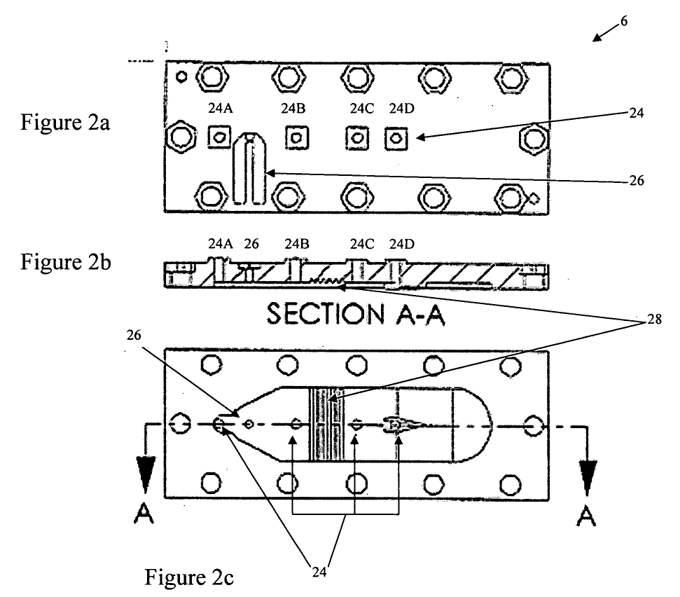

The inlet and outlet tubes are glued onto the same side of the Base Member 4, as is shown in FIG. 1. The inlet and outlet holes are aligned with a fluid path recessed into a mating piece. The mating piece is referred to as the flow block 6, and detailed in FIG. 2. Flow block 6 is connected to base member 4 on the side opposite the inlet and outlet tubes.

A recess 22 is milled into flow block 6, such that when the base member 4 and the flow block 6 are assembled, the recess 22 creates a fluid path from the inlet hole 16 to the outlet hole 18 of the base member 4. The recess 22 is shaped to generally form an initial semi-circular entry that gradually tapers out towards a thin rectangular cross-section for the fluid flow that forms a larger semi-circular end (see FIGS. 2b and 2c). In a preferred embodiment, flow block is about 2.5 inches long and about 1.0 inch wide and about 0.35 inch high, and thus, the rectangular cross-section forming recess 22 is about 1.8 inches long, about 0.5 inches wide and about 0.025 inches high. Small changes in the height of the recess 22 can cause significant error in the data acquired. Because ceramic has a low thermal coefficient of expansion and modulus of elasticity, relative to most plastics, in the preferred embodiment, a ceramic flow block and base member is used to reduce changes in the shape of the meter when temperature or pressure changes.

The flow block 6 also contains four (4) sensor port holes 24 that allow the fluid from the fluid path to contact four (4) MEMS pressure sensors 8, which are discussed below.

The flow block 6 guides the fluid from the inlet tube 16, through a right angle turn, expanding to a rectangular cross sectional area that is smaller than the circular cross sectional area of the inlet tube 16. In a preferred embodiment, the inlet tube has about a 0.25 inch ID, and the outlet tube, when used in conjunction with honeycomb 20, is about 0.5 inch narrowing to about 0.25 inch. In the preferred embodiment, as used on a soda dispensing system, the rectangular cross section has a width that ranges from about 0.25 inch to about 1 inch with about 0.5 inch being most preferable; a height that ranges from about 0.02 inch to about 0.065 inch with 0.025 being preferable; and a length that ranges from about 2.2 inches to about 1.4 inched. In an alternative embodiment, height of recess 22 is stepped. In this embodiment, the height decreases from about from about 0.04 inch to about 0.03 inch across the length of said recess 22. The fluid velocity increases at this area of recess 22. A pressure sensor port 24 is located at the beginning and at the end of this transition detecting any change in pressure caused by increased velocity and by turbulence.

A temperature sensor 26 is also located on the fluid surface of the Flow Block 6 in this area. It projects slightly, but does not significantly interfere with the flow. The fluid then continues across several recessed grooves 28, which cause increased turbulence in the fluid. The turbulence causes pressure of the fluid to drop. Another pressure port 24 is located after the grooves 28. The fluid then meets a pitot-tube type port 30. Traveling around this port it then exits through the honeycomb flow conditioner 20 and outlet hole 18. In an alternative embodiment, the pitot tube can be replaced by a step that reduces the cross-sectional area of the flow path. In one example of this alternative embodiment, said step is a reduction in height of recess 22 across its length. For example, said height can decrease from about 0.04 inch near the inlet hole to about 0.03 inch at the outlet hole. This alternative feature is not as restrictive as the pilot tube and is less prone to clog from debris. Like the pilot tube, it has an element of density dependence because the fluid velocity must increase.

The height and width of the rectangular flow path formed by recess 22 can be changed in order to better match the unique pressure drops associated with a variety of different liquids. The flow meter 2 described in the preferred embodiment is designed to run with soda water or sugar syrup with no modifications required. However, the current invention is capable of use with any flowing liquids, and thus finds use and applicability to a variety of devices.

One benefit of the invention is that the geometry of the flow body is adjusted such that the same flow meter geometry can be used for a variety of fluids. Thus, when the flow meter system of the current invention is used with a soda fountain a flow meter having the same geometry is used for either soda water or for syrup. Thus the flow meter of the current invention is highly versatile, and can be applied to a variety of fluids with only slight to no modifications to geometry.

Pressure limits in industry are given for the soda water and the syrup in typical soda fountain applications (e.g. soda water at 4 oz/s should have a maximum pressure drop of about 40 PSI, while cold syrup at 1 oz/s should have a maximum pressure drop of about 20 PSI). This invention optimizes the overall pressure drops for either case to the allowable maximums, thus creating the largest pressure signals possible for both cases. This is done by adjusting the height to width ratio of the cross section of the flow body channel. For example, a thinner cross section will restrict the viscous sugar syrup more than the soda water because of said syrup viscosity. At maximum flow rates, a thin cross-section in the meter would create a much higher pressure with the syrup than with the soda water. Conversely, a more square shaped cross-section would produce a much lower pressure with the syrup than the soda water. The soda water is thinner, so the pressure drop is smaller than that of sugar syrups at any given rate. But, the soda water runs at a rate 4-5 times faster than sugar syrup, raising the pressure drop of the water relative to the syrup. The cross section of the rectangular recess 22 can be adjusted in both width and height to create the desired pressure drops (e.g., 40 psi for soda water and 20 psi for syrup) for a desired fluid. Those of ordinary skill in the art will readily adjust the dimensions of the current invention's recess 22 to facilitate it use with a variety of fluids. Such adjustments are well within the spirit of the current invention.

The advantage of this technique is that is maximizes the pressure signals. If this technique is not used, the signal under one condition (like with cold syrup) could be very high, while the signal under the other condition (like with soda water) would be very weak, or visa-versa.

It has been determined that the largest pressure drop with soda water is at the 90 degree bend. Increasing the height or width of the flow path will decrease the total pressure drop of the soda water because it opens the flow path, and decreases the fluid velocity change. The largest pressure drop using syrup is over the rectangular cross-section because of its higher viscosity. Increasing the height or width of the flow path will also decrease the total pressure drop of the syrup. However, the relationship between the height of the flow path and the fluid is much stronger with syrupy fluids than with watery fluids. Small changes in the height will affect the pressure drop with syrup much more than with water. This difference allows the pressure limits to be matched to their required values, (e.g., soda water to 40 psi and syrup to 20 psi). The height is the most critical factor in the matching. The length of this restriction can also be adjusted to increase or decrease the pressure drops. Thus the current invention, therefore, creates a single path that produces optimal pressure drops for a variety of fluids, (e.g., 40 PSI pressure drop with soda water at 4 oz/s, and a pressure drop of 20 PSI using cold sugar syrup at 1 oz/s).

The shape of the inlet hole 16 radius on the base member 4 at the first 90 degree bend in the fluid path can be small or more rounded. A small radius can increase any pressure drop significantly due to turbulent flow. With a smaller radius, the pressure drop becomes more viscosity dependent and less density dependent. A large radius on this corner will lower the pressure, decrease turbulence and leave a smaller signal, but it will be more dependent on density.

A highly density dependent pressure drop occurs at the transition between the first two sensors at the 90 degree bend, and a highly viscosity dependent pressure drop occurs across the flat cross-section area. Having one signal that is highly density dependent and one that is highly viscosity dependent is a key element of the flow meter design, discussed below. Thus, the flow meter of the current invention is at least three meters in one, wherein every detected pressure drop is an indicator. The use of the pressure drop across the 90 degree transition, for example, could be used on it's own to determine the flow rate; however, such single metered measurements are often inaccurate. By placing another one right in line (pressure drop across the thin area), the second meter can be used to both check other conditions or fluid properties and correct the data collected by the first meter. Under some circumstances, those two might show a flow rate, but they may also be inaccurate, so the third indicator (another pressure sensor or temperature) can be used to check them and correct them. Thus, the flow meter of the current invention has at least three sensors for measuring three independent variables: flow, viscosity, and density, (temperature is a function of viscosity and density for sugar syrups, so it is not independent), as well as to correct data collected in the first meter.

Micro-Electromechanical Sensors (MEMS) pressure sensor elements are preferably used for sensors 8. These elements consist of a silicon-based MEMS pressure sensor die with a partially conductive gasket covering the electrical contacts on one side, and another gasket on the opposite side. The gasket and die assemblies are placed over each hole in the Flow Block 6. Those of ordinary skill in the art are readily familiar with MEMS and sensor technologies.

The sensors are mounted on the opposite side of the Flow Block 6. The port holes 24 are positioned at strategic points along the fluid path in recess 22. Between these holes, restrictions on the fluid flow cause pressure drops as discussed previously. The pressure at each port hole 24 is detected by its respective pressure sensor 8.

A sensor housing 12 was placed around the pressure sensor 8 assemblies. The geometry of this sensor housing 12 closely duplicates the original MEMS pressure sensor housing. The sensor housing 12 holds the pressure sensor 8 assemblies in the right location over the ports 24. The conductive pressure sensor gaskets are left exposed to contact the contact board 14. The gaskets on the opposite side seal against the flow block 6.

A thermistor 10 is mounted in the flow block 6 so that it is in contact with fluid in the inlet area. Small conductive contact pins are soldered to the thermistor leads. These contact pins protruded through the sensor housing 12 and are positioned to make electrical contact with the contact board 14.

Over the sensor housing 12 is placed a circuit board called the contact board 14. The contact board 14 makes direct contact with the conductive pressure sensor gaskets and the thermistor 10 pins. The contact board 14 is routed to connect the contact points for the pressure sensors 8 and the thermistor 10 to cable leads positioned on the opposite side of said contact board 14. A stiff support is mounted over the contact board 14 to increase the rigidity of the assembly.

The base member 4, flow block 6, pressure sensors 8, thermistor 10, Sensor Housing 12 and Contact Board 14, along with assembly hardware constitutes the preferred embodiment for the Flow Meter Assembly. Said flow meter assembly is shown in FIGS. 1 and 2. One of ordinary skill in the art will readily apply the teachings of the current invention to a variety of flow measure systems. Such applications and variations are well within the spirit of the current invention.

Cables connect the contact board 14 with an analog test board. The analog test board consists of electronic circuits to drive the four pressure sensors 8 and thermistor 10, and provide corresponding voltage output signals. It also contains circuits that generate analog differences between the pressure sensor voltage signals. It is preferred that signal errors are eliminated using the pressure differences obtained from an analog circuit, rather than mathematically subtracting them in the digital domain because the signals can change in the time that it takes to sample two pressure sensors. Sampling one analog signal gives an instantaneous reading of the pressure difference.

In a preferred embodiment, a piston pump is connected to the inlet hole 16 of the flow meter using stiff tubing. The pump is driven by a stepper-motor, and is capable of delivering fluid at precise rates. The piston pump is used for calibration and preliminary volume tests. Other types of pumps can be used, and such use of other pumps is well within the spirit of the current invention.

Preferably, a scale having 0.1 gram resolution is placed at the outlet of the flow meter assembly. A container is placed on the scale and fluid from the flow meter falls freely into said container. The scale should have a serial interface allowing for data acquisition equipment to tare the scale (set the scale reading to zero) and read the scale value after each pour or calibration run.

Data acquisition and process control software and hardware is installed and programmed on a PC. This equipment is used to drive the piston pump, tare and read the scale, read the voltage values from the analog test board and provide time stamps for each sample of the data. Before each run, the scale is tarred. Next, the piston pump is activated. Voltage samples are then taken across all channels of the analog test board every 10 ms through the duration of the run. After the run, the scale is read, and a text file is generated and saved.

The file contains a log of the programmed settings, voltage readings with corresponding time stamps, and the final scale reading.

The system is calibrated to generate a flow rate value based directly on the readings from the pressure sensors 8 and the thermistor 10. This is unlike the flow meters of the prior art wherein the data acquired from pressure sensors is combined with a variety of other data, such as inlet duct size diameter, renolds equations and the like, for making calculations of flow rate. For the current invention, a matrix is developed allowing the flow rate of a test sample to be calculated directly from the pressure voltage. A given fluid is pumped through the flow body 2 at a constant flow rate using the piston pump. Pressure readings are sampled along with temperature. The flow rate is then changed and the corresponding pressures and temperature are again sampled. Changes in temperature of the fluid creates pressure changes at a given flow rate, so several temperatures are sampled at several flow rates for each fluid. The process is repeated with different fluids, thereby generating a matrix containing flow rate, pressure and temperature data for the fluids. The pressures that are used in the matrix are the differential pressures (differences between separate pressure ports 24 generated on the analog test board). Two or more of these different values are used to generate the flow rate algorithm.

Data from the matrix of flow rates, pressures and temperatures is then conditioned (outliers and repeated values were thrown out) and processed using software. This generates a mathematical formula for flow rate, with flow rate as a function of the sensor outputs. Any combination of relationships can be used, as long as there are at least three independent values:

Q=f(P1, P2, T) Eq. 1.

Q=f(P1, P2, P3) Eq. 2.

Q=f(P1, P2, P3, T) Eq. 3.

Where Q is the flow rate, P1 is the first differential pressure sensor, P2 is the second differential pressure sensor, P3 is the third differential pressure sensor, and T is temperature of the fluid. For syrups where viscosity, density and temperature are dependent upon each other (one cannot change without one of the others changing), temperature can be used as one of three variables as in Equation 1. This is the case with sugar containing syrups. For other fluids, more information is required as in Equations 2 and 3.

The same process is used to generate density or viscosity information along like with flow rate, provided that this information is available while calibrating as with a known flow rate. The density of the fluid can be observed by dividing the mass of a pour (measured by the scale) by the volume of the pour (derived from the distance the piston pump traveled). Density is then substituted into the equations:

ρ=f(P1, P2, T) Eq. 4.

ρ=f(P1, P2, P3) Eq. 5.

ρ=f(P1, P2, P3, T) Eq. 6.

Where ρ is the density of the fluid.

For viscosity, using the current set-up, only a qualitative value of the viscosity can be generated by using a function of the viscosity and density dependent pressure drops. Of course, if the meter is intended to be a viscosity meter, and a viscometer is used during the calibration process, the viscosity readings can be associated with the sensor outputs just like flow rate, and a relationship can be found in a similar manner, using equations:

υ=f(P1, P2, T) Eq. 7.

υ=f(P1, P2, P3) Eq. 8.

υ=f(P1, P2, P3, T) Eq. 9.

Where υ is the viscosity of the fluid.

Two basic methods of determining the flow rate can be used to employ an empirical data set. The first is an interpolation algorithm; the other is a direct mathematical formula. Interpolation can be very accurate, regardless of the shape of the functions, but may require data that is well outside the intended rage of operation. Mathematical formulas can also be used. The shapes of the functions are very important here. A wide variety of formula forms can be used; however, in a preferred method a 2nd or 3rd order multivariate polynomial is used. It is important to precondition the data (taking the square root of some of the pressure values) before processing the data into formulas.

The shape of the pressure to flow rate relationship has much to do with the Renolds number and with whether the flow is laminar or turbulent or is going through transition. It is preferred that the flow is either in a laminar state or a turbulent state because of inconsistencies in the transitional areas.

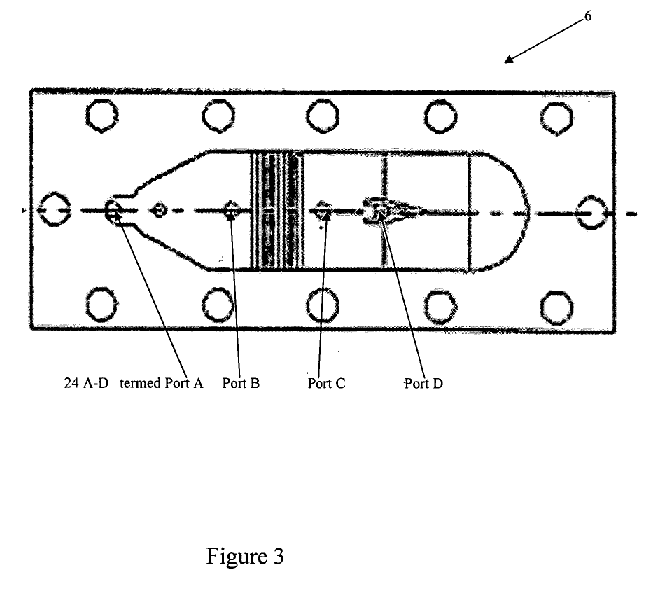

If a mathematical formula is used, it is unlikely that the data from of soda water, diet syrup and sugar syrups under all temperatures and flow rates will fit well using a single formula. Basic information from the indicators can be used to classify the fluid. Separate formulas can be generated during the calibration process, and selected based on the fluid class. For example, when sugar syrups are in the system, the ratio between the Port A-Port B pressure drop and the Port B-Port C pressure drop is very different than when soda water or diet syrups are flowing. (Port A, B, C and D refer to sensor ports 24, and are generally aligned according to FIG. 3. The ports are aligned by way of example only, and an alternative aligning of the ports does not depart from the spirit of the current invention.) To tell the difference between soda water and diet syrup, magnitude of the Port A-Port B pressure drop can be used. It will be higher with soda water because of the higher flow rate.

Data is collected for individual pour tests using the pumps, fluids, discrete flow rates and varying temperatures specified. The data associated with each pour is stored as a text file in a format similar to the file format used in the calibration procedure. The text file is then evaluated using an algorithm; however, the evaluation could also be accomplished on a dedicated microprocessor. The algorithm calls on the pressures, temperatures, and the mathematical flow rate formula to evaluate each set of sampled data. A flow rate is then generated for the sample and the time for each sample is recorded as well. The volume is determined by multiplying the flow rate by the duration of the sampling time (−10 ms). These small volumes are calculated for each sample, and then added to a cumulative sum. At the end of the file, the sum represents the total volume for the pour.

To improve accuracy, a different mathematical formula is generated for syrup classes, (diet syrup, sugar syrup, soda water) in the calibration process. Since the pressure readings for these three fluid types are in distinct ranges, widely separated from each other, the algorithm looks at key indicators such as the ratio between the pressure differentials and the magnitude of the pressure differentials in order to determine which of the mathematical formulas to use. Once chosen, the formula is then applied to the entire run or file.

In an alternative embodiment of Applicant's flow meter system, the pressure sensors 8 are differential pressure sensors. Differential pressure sensors, where fluid is applied to both sides of a strain gage-type membrane, are much more resistant to damage by a pressure spike because the force of the pressure is applied on both sides of the meter. By using differential pressure sensors 8, the reading between two ports that generate a pressure drop of 15 PSI, for example, can be measured using a 15 PSI pressure sensor. If using gage pressure sensors, all of the sensors should have a significantly higher rating in order to withstand pressure spikes in the line. Pressure spikes can be as much as several hundred PSI, which will damage most gage sensors. Large pressure spikes can be further reduced with the uses of a plenum. A plenum is a small camber filled with air or other compressible material that is in contact with the inlet fluid. As pressure spikes or vibrations travel toward the meter, they are damped by the plenum. The plenum can absorb and release the fluid's kinetic energy, thereby smoothing the fluid flow and preventing damaging pressure spikes.

Using the lowest possible rating of the differential pressure sensors can maximize their sensitivity. This can be accomplished by installing pressure sensors that are rated at the maximum pressure drop that the pressure sensor will experience.

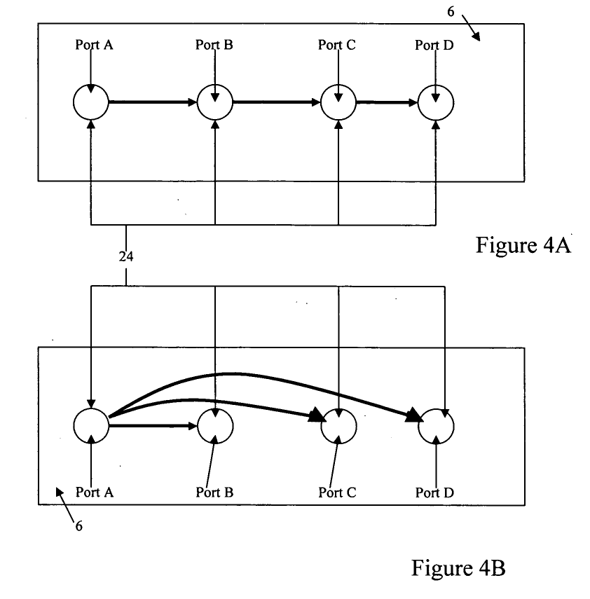

With differential pressure sensors, the fluid must be routed to the back of the pressure sensor. This routing can be done in two basic ways. As shown in FIG. 4a, the differential pressure sensor can be routed from Port A to Port B, then another from Port B to Port C, and the last from Port C to Port D. In this alternative configuration the pressure sensors 8 are each measuring the small pressure drops from port to port. The sensitivity is maximized; however, error is increased when combining the sensor readings for some calculations.

A further alternative method is to route the differential pressure sensors from Port A to Port B, then another from Port A to Port C, and the last from Port A to Port D. See FIG. 4b. In this way the pressure sensors are each measuring the cumulative drop from the first port. The last sensor measures the entire pressure drop across the meter. This can be an advantage when the accuracy of the meter relies upon mathematical calculations that require the value for the entire pressure drop. Any time the values of the pressure sensors need to be manipulated in the digital domain, errors can rise.

By resetting the value of the pressure drop to zero when there is no flow will help account for drift that is sometimes associated with the less expensive sensors, thereby improving accuracy. Initially, the voltage of the sensor is set to zero, but because of the more complex nature of the algorithm, the pressure should be determined, then it should be offset by a pressure value adjustment for the run.

It is possible to detect the temperature of the fluid based on other electronic values read from the pressure sensors. If these values are sampled it may allow the elimination of the temperature sensor. If this is the case, the pressure sensors should be placed in close proximity to the flow path. That way they will be more sensitive to the change in temperature of the fluid. This method is not recommended if the temperature reading is to be used for flow rate calculations because the response time of the pressure sensor will most likely be too slow.

A preferred method is to use properly temperature compensated pressure sensors and remove the sensors from the flow path to further reduce the possibility of errors due to rapid fluid temperature changes. If the algorithm resets the pressure value to zero before each run, the temperature effects will have a minimal impact on accuracy so long as the pressure sensors are buffered from dramatic changed in temperature during the run.

A bubble in the routing tube can cause large errors with rapidly transitioning flow rates. This is because the fluid will have to move through the narrow routing path. The movement takes time and will cause a lag in the time as the pressures in the flow path and at the sensor equalize. With no bubble, fluid transmits the pressure directly to the sensor with negligible movement.

There are at least three ways to reduce errors caused by bubbles in the routing. A first method is to locate the ports below the flow path. A second method is to make the port routing relatively large after the initial port hole. This way if a bubble does get into the routing, its effects will be minimized. Third, a membrane can be located between the flow path and the ports. It must be flexible in order to effectively transmit the pressure. Those of ordinary skill in the art will readily exercise a variety of methods for eliminating or minimizing the errors caused by bubbles in the routing line. Alternatively, elongating the pressure ports across the flow path can reduce errors caused by localized swirling of the fluid. This also allows fluid to travel in and out of the port more freely, reducing errors cause by bubbles.

The absolute line pressure can also affect the reading of a differential pressure sensor. The direction and rate of change of the reading can cause error as well (Hysteresis). Temperature may also affect the reading of the pressure sensors. If the pressure sensors need additional temperature compensation, this can come from a value read from the sensor that is based on the temperature of the pressure sensor. The corrected pressure can therefore be represented by the following function:

P_{C}=f(V_{P}, V_{P}/t, P_{LINE}+Pᵤ/2, T)

Where:

P_{C}=the corrected differential pressure.

V_{P}=the voltage reading from the differential pressure sensor.

V_{P}/t=the change in the voltage reading from the differential pressure sensor divided by a corresponding change in time, in other words the rate of change of the differential pressure.

P_{LINE}=the line pressure.

P_{U}=the differential pressure based on a constant multiplied by V_{P}.

T=a reading that corresponds to the temperature of the pressure sensor. If there is already sufficient thermal correction for the sensor, this variable can be eliminated from the formula.

Using these corrections, the accuracy of inexpensive sensors can be significantly improved.

For low flow fluids (e.g., diet syrup), the signal is smallest. Redundant formulas based on more than one sensor can be used to calculate the flow rate. This will work if the error associated with the sensors is random and if both sensors used generate about the same amount of error.

During calibration, ideally a fluid is pumped through the meter at a programmed, known rate. If the actual flow rate deviates from the programmed flow rate (due to vibration, tube compliance pump ramping plenum dampening, etc.) error will be introduced to the system. This error can be greatly reduced by ensuring steady state conditions or by generating a temporary flow rate estimate. A temporary flow rate estimate can be generated by observing a single pressure drop signal through the run and making a simple calibration for that run base on it. Since the conditions (temperature and fluid) are relatively stable for a single run, a simple estimate of the flow rate can be generated based on a single pressure sensor reading. This temporary flow rate estimate accurately tracks small unintentional changes in flow rate. These estimated changes are then be associated with the small variations of the readings at any point in time in the run. The data set that is gathered will have more accurate flow rate information, thus improving the accuracy of the final calibration, when all of the data is used to crate a general formula or is used in an interpolation data set.

A variety of flow meter systems can be created incorporating the any or all of the improvements mentioned above. Those of skill in that art will readily make flow meter sensors incorporating the current invention and any or all of the alternative configurations described above or known in the art. Such flow meters are well within the spirit of the current invention.

I claim:

1. A device for continuously measuring multiple properties from a variety of fluids in motion, comprising:
a fluid inlet;
an optimally dimensioned fluid path;
at least three sensors;
a data acquisition and analysis means for accurately determining multiple properties of a variety of fluids in motion; and
a fluid outlet,
wherein said at least three sensors measure the pressure and optionally the temperature of said variety of fluids in motion; wherein at least two of the said at least three sensors are pressure sensors and wherein data acquired from said at least three sensors is analyzed in order to calculate properties relating to the variety of fluids in motion, said properties selected from the group comprising; viscosity, density, velocity, flow rate, pressure and temperature.

2. A fluid flow measuring device comprising a recessed fluid pathway to optimally receive a fluid in motion for precise measurements of properties selected from the group comprising; viscosity, velocity, density, temperature and pressure.

3. A method for continuously measuring properties of a variety of fluids in motion comprising the steps of:
pumping a fluid in motion into a flow block comprising an optimally dimensioned recessed flow path;
sensing a variety of parameters of said fluid in motion using a series of sensors optimally positioned within said recessed flow path;
acquiring data directly from the sensors and analyzing said data using a matrix; and
using said analyzed data to report properties relating to said fluid in motion, said properties selected from the group comprising; viscosity, density, velocity, flow rate, pressure and temperature.
